(19) United States
(12) Patent Application Publication
(10) Pub. No.: US 2014/0000764 A1
(43) Pub. Date: Jan. 2, 2014

(54) PLASTIC PROCESSING COMPONENT WITH MODIFIED STEEL SURFACE

(71) Applicants: Michael Zumkeller-Neidlinger, Lorrach (DE); Gerhard Peyerl, Geisenheim (DE)

(72) Inventors: Michael Zumkeller-Neidlinger, Lorrach (DE); Gerhard Peyerl, Geisenheim (DE)

(73) Assignee: OERLIKON TRADING AG, TRUBBACH, Trubbach (CH)

(21) Appl. No.: 13/990,972

(22) PCT Filed: Nov. 23, 2011
(86) PCT No.: PCT/EP2011/005892

§ 371 Date: Sep. 18, 2013

(30) Foreign Application Priority Data
Dec. 1, 2010 (DE) 10 2010 052 894.3

(51) Int. Cl. B29C 33/38

(52) U.S. Cl. CPC B29C 33/3842
USPC 148/318; 148/222

(57) ABSTRACT

The invention relates to a component for processing plastic, the surface of said component being modified. The surface base material is steel, and according to the invention nitrogen is preferably diffused into the steel to a thickness of 400 μm, thus forming a diffusion layer. The surface comprises a smoothed covering layer that substantially contains nitrogen-iron compounds.

The present invention relates to a modified steel surface for components for processing plastic.

Known plastic products processed in this way are for example diffusing panels of automobile headlights, instrument panel surrounds in the automobile industry. Another wide field of application is in medical technology. For example, incubation hoods for infants or also pipettes or diffusing panels for lenses among others are produced in this manner by means of such components. in the case of such plastic products, the optical properties of their surface nearly always play a prominent role. This requires good reproduction fidelity from the tools forming such a product.

Considerable demands are made of the surface of such components for processing plastic:

great hardness and resistance to wear
no growing and no embrittlement
easy to repair, i.e. capable of being polished, re-blasted and welded
a reproduction of the functional surface that is as true as possible

An attempt is made to achieve this in DE 10359321 by coating the surface of the components with a layer of hard material that provides on the one hand protection against wear and tear and on the other hand ensures good reproduction fidelity. The reproduction fidelity is achieved in that the layer thickness is chosen according to the thermal effusivity of the layer material in such as way that a predefined gloss level is achieved.

The disadvantage in this connection is that in order to repair the surface, the latter first needs to be completely stripped of the layer and the subsequent coating requires a usually cost-intensive coating process under vacuum conditions.

On the other hand, it has been proposed with reference to Caveo, using a special diffusion process, to embed elements in the surface that will transform the steel itself into a ceramic-like, nearly amorphous surface layer. However, it is not known how such a special diffusion process could look like and which elements would be used for diffusion. Furthermore, it is to be expected that after the formation of the above-mentioned ceramic-like amorphous surface layer, the diffusion process would come at least nearly to a standstill due to this surface layer. R can thus however be speculated that the thickness of the amorphous surface layer is limited to a few micrometers and a repair or post-processing can thus again be ruled out.

It is an aim of the present invention to propose a surface modification with which the above-mentioned disadvantages of the state of the art can be at least partly overcome.

In another context, it is known to nitrify metallic surfaces of workpieces in order to increase their resistance to corrosion and protect them against wear and tear. This can be achieved by means of the widespread plasma nitrification whereby the workpieces to be nitrified are exposed to a plasma with hydrogen and nitrogen ions under vacuum conditions. Nitrification with pulsed plasma has been known since 1980. The pulsing has several advantages, since on the one hand the process temperature can be selected to a large extent by adjusting the pulse duration without having to modify the other process parameters such as for example the voltage between the electrodes, and on the other hand the pulsing can to the greatest extent prevent spark formation during the nitrification process.

Nitrification takes place with the diffusion of nitrogen in the surface of the basic material, whereby a nitrification zone is formed in which, dose to the surface, the nitrogen combines with the materials of the workpiece or, somewhat lower, the nitrogen forms a so-called solid solution with the basic material. This nitrification zone is therefore generally composed of a bonding layer and of a diffusion layer. Accordingly, in the bonding layer, nitride compounds are mainly present. In the case of substrates containing iron, it is possible for example for ε-nitride (=Fe₂₍₃₎N) and/or γ′-nitride (=Fe₄N) to form in the bonding layer.

The PPD™ process has so far not been used for components for processing plastic since the mentioned bonding layer, after formation, has a roughness that results in an inacceptable surface roughness on the plastic surface.

When working towards improving the surface modification of components for processing plastic, the inventors surprisingly noticed that the bonding layer of a steel surface modified by means of PPD™ could be very well polished and in particular could be polished to a high gloss in order to achieve the desired degree of gloss. Thereby, the surface is modified according to the invention in such a manner that a diffusion layer resistant to wear protection and a ceramic-like polished surface layer are formed.

It is possible to coat with this method all types of steel that up to 530° C. exhibit essentially no dimensional changes. Examples of this are 1.2311, 1.2738, 1.2316, 1.2343, 1.2344, 1.2379, 1.2083 (secondary heat treatment).

When performing the PPD™ process, the following steps for example are comprised:
loading a vacuum chamber with at least one substrate to be nitrified, wherein the at least one substrate is held isolated electrically from the chamber wall in such a manner that the chamber wall can build an anode and the at least one substrate to be nitrified can build at least part of a cathode;
closing the chamber by sealing an opening or several openings through which the vacuum chamber was loaded with the at least one substrate to be nitrified;
evacuating the vacuum chamber to a work pressure;
letting in a gas mixture into the vacuum chamber, wherein the gas mixture contains both hydrogen as well as nitrogen in elemental and/or bound form;
performing the nitrification by applying a pulsed voltage between anode and cathode in such a way that the gas mixture is ionized and a plasma is formed in the chamber.

According to the invention, the thickness of the bonding layer formed with the method is reduced by more than 5 μm, in particular preferably by 8 μm, by means of polishing the surface.

The inventive method (PPD™ process with subsequent post-polishing of the surface layer) results in a diffusion depth of up to 0.4 mm. Diffusion processes are by nature always connected with gradients, It is thus difficult to speak of an absolute diffusion depth. By definition, in the frame of this description one should assume that the thickness of the diffusion layer is limited by the nitrogen concentration there declining to lie as compared to the maximum concentration in the diffusion layer. Diffusion depths greater than 400 μm can be achieved but result in uneconomically long process times. The surface layer with a thickness originally up to 15 μm can be easily polished and preferably has a thickness after polishing of approx. 7 μm, The hardness of the surface layer is up to 1200 HV*, whereby a high resistance to wear and tear can be achieved. The corresponding surface, when used, exhibits an improved demolding behavior, lower friction values and less deposit formation as compared with the unmodified surface.

The inventive surface modification has, among others, the advantages that a considerably better surface brilliance of the processed plastics, in particular for clear parts, is achieved, the demoldability is considerably improved and thus the cycle time is reduced. All geometries can essentially be dealt with and the susceptibility to scratches is considerably reduced. Furthermore, the phenomenon known under the term “orange peel” is prevented or at least considerably reduced, This phenomenon can occur when steel surfaces are directly polished and steel components of varying hardness break away differently and thus leave a surface structure (generally dents). By means of the inventive surface configuration, which includes a diffusion layer and a ceramic-like surface layer, this “orange peel” is no longer formed during polishing.

Furthermore, the surface is easy to repair. In particular, for necessary welding work, the surface layer can be removed prior to welding at the corresponding area so that the diffusion layer is accessible for welding. A short PPD™ post-processing then results in a renewed surface layer which can be post-polished in a simple manner.

In a particularly advantageous embodiment of the present invention, great care is given that the surface layer contains essentially only ε-nitride (=Fe₂₍₃₎N) or essentially only γ′-nitirde (=Fe₄N), since, when both iron-nitride compounds are generated, an undesirably porous layer can be formed.

If in the process gas a nitrogen concentration of 15-30 vol. % is chosen, a bonding layer can be achieved that contains only γ′-nitride. A popular way of achieving this is using ammoniac as process gas.

A bonding layer that contains merely c-nitride can be achieved if 1-3 vol. % CH₄ is added to the process gas. Such a process is then called nitro-carburation.

In the frame of this description, a polished surface layer was taken as the basis. In this context, it is obviously dear that structured surfaces, especially if they are small structures, are difficult to polish, if at all. Other smoothing methods can however be used here. By smoothing rasp. by a smooth layer, it is not the leveling of the desired surface structure that is meant but the reduction of the roughness overlying this surface structure essentially induced by the surface layer. By way of such a smoothing method, abrasive cleaning (shot penning, blasting) with small, not necessarily round shot can be used.

In the frame of the present description, an inventive component for processing plastic was disclosed with a surface which is designed for coming into contact with plastic during its processing, wherein the basic material of the surface consists of steel and the surface is modified, characterized in that the areas dose to the surface comprise a nitrogen diffusion layer that has a thickness of at least 150 μm, preferably greater than 200 μm and in particular is preferably approx. 400 μm thick, and in that the surface comprises a smooth surface layer which is formed essentially through iron-nitrogen compounds. The smooth surface layer can be a surface layer polished to a high gloss. The smooth surface layer can have a thickness of more than 4 μm and is preferably 7 μm thick.

Preferably, the surface layer contains essentially merely ε-nitride (=Fe₂₍₃₎Nu) or essentially merely γ′-nitride (=Fe₄N).

An inventive method for producing a component for processing plastic was disclosed comprising the following steps:
loading a vacuum chamber with at least one substrate to be nitrified, wherein the at least one substrate is held isolated electrically from the chamber wall in such a manner that the chamber wall can build an anode and the at least one substrate to be nitrified can build at least part of a cathode;
dosing the chamber by sealing an opening or several openings through which the vacuum chamber was loaded with the at least one substrate to be nitrified;
evacuating the vacuum chamber to a work pressure;
letting in a gas mixture into the vacuum chamber, wherein the gas mixture contains both hydrogen as well as nitrogen in elemental and/or bound form;
performing the nitrification by applying a pulsed voltage between anode and cathode in such a way that the gas mixture is ionized and a plasma is formed in the chamber,

characterized in that the substrate is a component for processing plastic and in a further step the thickness of the bonding layer resulting during the process is reduced by means of polishing the surface.

In said further step, the thickness of the bonding layer formed with the method is reduced by more than 5 μm, in particular preferably by 8 μm, by means of polishing the surface.

During the process, the gas mixture can contain a nitrogen concentration of 15-30 vol. % in order to achieve essentially only γ′-nitride in the surface layer.

During the process, 1-3 vol. % CH₄ can be added to the process gas in order to achieve essentially only ε-nitride (=Fe₂₍₃₎N). This occurs preferably at a nitrogen concentration >30 vol. %.

1. Component for processing plastic with a surface which is designed for coming into contact with plastic during its processing, wherein the basic material of the surface consists of steel and the surface is modified, characterized in that the areas close to the surface comprise a nitrogen diffusion layer that has a thickness of at least 150 μm, preferably greater than 200 μm and in particular is preferably approx. 400 μm thick, and in that the surface comprises a smooth surface layer which is formed essentially through iron-nitrogen compounds.

2. Component for processing plastic according to claim 1, characterized in that the smooth surface layer can be a surface layer polished to a high gloss.

3. Component for processing plastic according to one of the preceding claims, characterized in that the smooth surface layer can have a thickness of more than 4 μm and is preferably 7 μm thick.

4. Component for processing plastic according to one of the preceding claims, characterized in that the surface layer contains essentially merely ε-nitride (=Fe₂₍₃₎N) or essentially merely γ′-nitride (=Fe₄N).

5. Method for producing a component for processing plastic with the following steps:
loading a vacuum chamber with at least one substrate to be nitrified, wherein the at least one substrate is held isolated electrically from the chamber wall in such a manner that the chamber wall can build an anode and the at least one substrate to be nitrified can build at least part of a cathode;
closing the chamber by sealing an opening or several openings through which the vacuum chamber was loaded with the at least one substrate to be nitrified;
evacuating the vacuum chamber to a work pressure:
letting in a gas mixture into the vacuum chamber, wherein the gas mixture contains both hydrogen as well as nitrogen in elemental and/or bound form;
performing the nitrification by applying a pulsed voltage between anode and cathode in such a way that the gas mixture is ionized and a plasma is formed in the chamber,
characterized in that the substrate is a component for processing plastic and in a further step the thickness of the bonding layer resulting during the process is reduced by means of polishing the surface.

6. Method according to claim 5, characterized in that in said further step, the thickness of the bonding layer formed with the method is reduced by more than 5 μm, in particular preferably by 8 μm, by means of polishing the surface.

7. Method according to claim 5, characterized in that the gas mixture contains a nitrogen concentration of 15-30 vol. %.

8. Method according to one of the claim 5 or 6, characterized in that 1-3 vol. % CH₄ can be added to the process gas.
